(19) United States
(12) Patent Application Publication
(10) Pub. No.: US 2020/0311715 A1
(43) Pub. Date: Oct. 1, 2020

(54) METHODS AND APPARATUS FOR PAYMENT CARD ACTIVATION

(71) Applicant: Giesecke+Devrient Mobile Security Canada, Inc., Markham (CA)

(72) Inventor: Mehdi Zadeh HEIDARI, Maple (CA)

(73) Assignee: Giesecke+Devrient Mobile Security Canada, Inc., Markham (CA)

(21) Appl. No.: 16/369,920

(22) Filed: Mar. 29, 2019

(51) Int. Cl. G06Q 20/34

(52) U.S. Cl. CPC G06Q 20/354; G06K 7/1417

(57) ABSTRACT

An activation code to be provided to a cardholder associated with a payment card is generated. The activation code is an electronically scannable code that encodes payment card information associated with the payment card. The activation code is subsequently received from a user device, the activation code having been electronically scanned by the user device. The payment card information, associated with the payment card, is extracted from the activation code received from the user device. Activation of the payment card is performed using the payment card information extracted from the activation code received from the user device.

### FIELD OF THE DISCLOSURE

The present disclosure relates generally to provisioning of payment cards and, more particularly, to payment card activation.

### BACKGROUND

Payment cards, such as credit cards, debit cards, gift cards, virtual payment cards, and the like are widely-used as a convenient and efficient method for providing payments for products and services. Typically, when a payment card is issued by a card issuer and is provided to a consumer, the payment card needs to be activated by (or on behalf of) the consumer prior to being used by the consumer. Payment card activation is generally used to verify and authenticate the consumer to ensure that the card is in the hands of the intended cardholder of the payment card. To perform payment card activation, card issuers typically utilize telephone systems, such as human-operated and/or interactive voice response (IVR) systems, voice activated digital assistant systems, or on-line systems, such as webpages, that require the consumer to input a card number and certain identifying information that allows the system to verify that the consumer is indeed the person or entity to which the card being activated has been issued. Such typical card activation systems are often cumbersome and expensive for the card issuer to implement and maintain. Further, such typical card activation systems are often inconvenient for the consumer. For example, activation using such typical card activation systems may take the consumer several minutes to activate a single payment card. Moreover, such typical activation systems require that sensitive data, such as payment card number, consumer identifying information and the like, is provided from a consumer device to the payment card issuer, and such information may be provided via unsecured channels making the activation process vulnerable to hacking and fraud.

### SUMMARY

In an embodiment, a method for payment card activation includes generating, at a processor of a payment card service provider server device, an activation code to be provided to a cardholder associated with a payment card, the activation code being an electronically scannable code that encodes payment card information associated with the payment card. The method also includes receiving, at the processor of the payment card service provider server device, the activation code from a user device, the activation code having been electronically scanned by the user device. The method additionally includes extracting, using the processor of the payment card service provider server device, the payment card information, associated with the payment card, from the activation code received from the user device. The method further includes performing, using the processor of the payment card service provider server device, activation of the payment card using the payment card information extracted from the activation code received from the user device.

In another embodiment, a tangible, non-transitory computer readable medium, or media, storing machine-readable instructions that, when executed by one or more processors, cause the one or more processors to: generate an activation code to be provided to a cardholder associated with a payment card, the activation code being an electronically scannable code that encodes payment card information associated with the payment card; receive the activation code from a user device, the activation code having been electronically scanned by the user device; extract the payment card information, associated with the payment card, from the activation code received from the user device; and perform activation of the payment card using the payment card information extracted from the activation code received from the user device.

In yet another embodiment, a payment card activation apparatus comprises: an activation code generator implemented on one or more processor devices, the activation code generator configured to generate an activation code to be provided to a cardholder associated with a payment card, the activation code being an electronically scannable code that encodes payment card information associated with the payment card; a user interface implemented on the one or more processor devices, the user interface configured to receive the activation code from a user device, the activation code having been electronically scanned by the user device; and a card activation processor implemented on the one or more processor devices, the card activation processor configured to: extract the payment card information, associated with the payment card, from the activation code received from the user device, and perform activation of the payment card using the payment card information extracted from the activation code received from the user device.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a block diagram of a computing system in which payment card activation using an activation code may be implemented, according to an embodiment;

FIG. 2 is a block diagram of a payment card activation engine that may be used with the system of FIG. 1, according to an embodiment;

FIG. 3 is a diagram illustrating a payment card activation process that utilizes the payment card activation engine of FIG. 2, according to an embodiment;

FIG. 4 is a flow diagram illustrating a payment card activation method that is implemented by the payment card activation engine of FIG. 2, according to an embodiment; and

FIG. 5 is a diagram of a computer system suitable for implementing one or more components of the computing system of FIG. 1, according to an embodiment.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

Various examples and embodiments of the present disclosure will now be described. The following description provides specific details for a thorough understanding and enabling description of these examples. One of ordinary skill in the relevant art will understand, however, that one or more embodiments described herein may be practiced without many of these details. Likewise, one skilled in the relevant art will also understand that one or more embodiments of the present disclosure can include other features and/or functions not described in detail herein. Additionally, some well-known structures or functions may not be shown or described in detail below, so as to avoid unnecessarily obscuring the relevant description.

Embodiments described herein generally relate to methods and apparatus for payment card activation using payment card activation codes generated based on payment card information associated with payment cards. In an embodiment, a payment card service provider activation engine generates an activation code for activating a payment card. The activation code may be an electronically scannable code, such as a barcode, a matrix bar code (e.g., a quick response (QR) code), or may be any other suitable type of code. The payment card may be a credit card, a banking card, a payment-enabled wearable device (e.g., a tag, a bracelet, a ring, a watch, etc.), a gift card, or any other suitable type of medium usable for providing payments, obtaining funds, etc. The activation code may be generated to encode payment card information including one or more parameters associated with the payment card, such as payment card number, security code, expiration date, cardholder name, etc. In at least some embodiments, the payment card activation engine may be operated on a secure server, such as a payment card service provider server, for example. In at least some embodiments, the payment card information may be encrypted prior to code generation, and the activation code may be generated to encode the payment card information in encrypted form.

The activation code and the corresponding payment card may be provided to the cardholder associated with the payment card. The activation code may, for example, be printed on a sticker that may be affixed to the payment card (e.g., affixed to a credit card, affixed to a banking card, affixed to a payment-enabled wearable device, etc.), or may be included in a mailer that is mailed to the cardholder together with, or separately from, the payment card. Upon receiving the payment card, the cardholder may utilize the activation code to activate the payment card. For example, the cardholder may use a mobile or a stationary user device to electronically scan the activation code, may manually enter the activation code, etc. As one example, a user may electronically scan the activation code by utilizing a built-in camera of the user device to capture the activation code. An application on the user device may also be implemented to read, render or convert the activation code for data transmission. The electronically scanned or manually entered activation code may be transmitted to the payment card activation engine. The payment card activation engine may extract the payment card information encoded in the activation code, and, further, may decrypt the extracted payment card information. The payment card may then be activated using the extracted and decrypted payment card information. For example, the payment card activation engine may generate a payment card activation request that includes the payment card information in encrypted or decrypted form, and may provide the payment card activation request to an issuer of the payment card, such as a bank server. The issuer of the payment card may activate the associated payment card based on the payment card information. The payment card may then be ready to be utilized for its intended purpose by the cardholder.

Such payment card activation may provide very quick and convenient payment card activation to the cardholder. For example, the cardholder may complete the activation process by merely scanning the activation code using a mobile device, which may take only a few seconds of the cardholder's time. Moreover, because an activation code that encodes payment card information rather than the payment card information itself is used to activate the payment card, the payment card activation process does not require transmission of sensitive payment card information, such as card number, security code, expiration date, etc. in a manner that may not be sufficiently secure for such transmission and may result in fraudulent use of the payment card. Further, because the payment card information is encoded in the payment card activation code, the payment card information need not be separately stored by the payment card service provider. Thus, in at least some embodiments, only decryption method (e.g., information needed for decryption) and, in some cases, certain cardholder verifying information (e.g., an authentication code, a one-time password, etc.) is stored by the payment card service provider. Further still, such payment card activation process eliminates the need for the card issuer to develop and maintain alternative, typically less secure and more expensive, payment card activation systems, such as on-line or over the phone payment card activation systems.

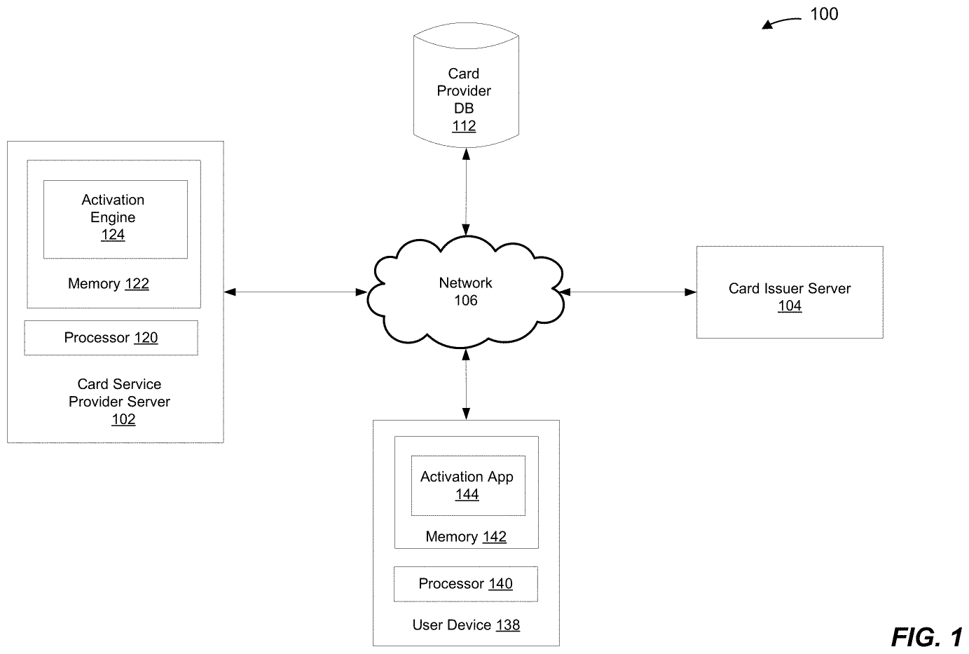

FIG. 1 is a block diagram of a computing system 100 in which payment card activation using an activation code may be implemented, according to an embodiment. Computing system 100 includes a payment card service provider server 102 communicatively coupled to one or more card issuer server devices 104 via a network 106. Network 106 may be a wide area network (WAN) such as the Internet, a local area network (LAN), or any other suitable type of network or mode of communication. Network 106 may be single network or may be made up of multiple different networks, in some embodiments. Computing system 100 may also include a card service provider database 112. Card service provider database 112 may be communicatively coupled to payment card service provider server 102 via network 106, as illustrated in FIG. 1, or may be coupled to card service provider server 102 in other suitable manners. For example, card database 112 may be directly connected to card service provider server 102, or may be included as part of card service provider server 102, in some embodiments. Card service provider database 112 may be a single database or may include multiple different databases. In an embodiment, card service provider server 102 and/or card service provider database 112 may be maintained in a secure manner. For example, card service provider server 102 and/or card service provider database 112 may be physically located in a fully secure area, such as a payment card industry (PCI) compliant area, and/or may be maintained in a secure cloud location. The secure cloud location that may have restricted access and/or may be protected by a firewall, for example.

Card service provider server 102 is illustrated in FIG. 1 as including a processor 120 and a computer readable memory 122 that stores computer readable instructions executable by processor 120. Computer readable memory 122 may store a card activation engine 124. Computer readable memory 122 may include volatile memory to store computer instructions, such as Random Access Memory (RAM), and may also include persistent memory such as a hard disk, for example. In some embodiments, card service provider server 102 includes multiple processors 120. Further, in some embodiments, card activation engine 124 may be implemented using hardware components, firmware components, software components, or any combination thereof.

Card service provider server 102 may receive, from card issuer server(s) 104, payment card orders or requests for provision of payment cards to cardholders and/or for services related to activation of payment cards to be provisioned to cardholders. Payment card orders or requests may be electronically transmitted from card issuer server(s) 104 to card service provider server 102 via network 106. Such payment card orders or requests may generally include information needed for provision of the payment cards to the cardholders, such as payment card information that is to be printed on or otherwise incorporated in a payment card (e.g., cardholder's name, payment card number, security code, expiration date, etc.), and may additionally include other information, such as a cardholder's e-mail address, mailing address, mobile number, etc. In some embodiments, such payment card orders or requests may include more limited payment card information that may be needed for activation of the card, for example when provision of the card is to be performed by the issuer of the card. Limited payment card information may include, for example, a partial payment card number, such as last four digits of the payment card number, instead of a full payment card number. Limited payment card information may additionally include other information that may be needed to provide activation of the payment card, such as cardholder's name, security code, expiration date, cardholder's e-mail address, mailing address, mobile number, etc.

Card service provider server 102 may at least temporarily store the information provided for provisioning and/or activation of a payment card in database 112. In at least some embodiments, sensitive information (e.g., cardholder's name, payment card number, security code, expiration date, etc.) provided to card service provider server 102 may be stored in database 112 for a prescribed maximum amount of time (e.g., 24 hours). Accordingly, card service provider server 102 may be configured to cause the sensitive information to be purged from the database upon expiration of the prescribed maximum amount of time, in an embodiment.

In an embodiment, upon receiving a payment card order message from card issuer server 104, card service provider server 102 may provide at least some payment card information, such as payment card number (e.g., credit card number, banking card number, gift card number, etc.), partial payment card number (e.g., last four digits of credit card number, last four digits of banking card number, last four digits of gift card number, etc.), payment card verification code (e.g., credit verification value (CVV)), expiration date, cardholder name and the like, included in the payment card order message to activation engine 124. Activation engine 124 may also generate an authentication code (e.g., a second factor authentication code), such as a one-time password (OTP), for activation of the payment card. Based on the payment card information, activation engine 124 may generate an activation code (e.g., a scannable code such as a one-dimensional or a multi-dimensional bar code) that encodes at least some payment card information. In some embodiments, activation engine 124 may generate the activation code further based on the authentication code generated for activation of the payment card, to further encode, within the activation code, the authentication code generated for activation of the payment card. Encoding the authentication code within the activation code allows authentication to be subsequently performed based on the activation code, by obtaining the authentication code from the activation code, in an embodiment.

In an embodiment, prior to encoding the payment card information, activation engine 124 may encrypt the payment card information and/or the authentication code generated for the payment card. In this embodiment, activation engine 124 may generate the activation code to encode the encrypted payment card information and/or the encrypted authentication code generated for the payment card. Activation engine 124 may store, in card service provider database 112, an association between a decryption key and identifying information for the payment card, in an embodiment. Activation engine 124 may additionally store, in card service provider database 112, an association between the authentication code generated for the payment card and identifying information for the payment card, in an embodiment. In some embodiments, authentication activation engine 124 may be configured to subsequently perform authentication using the authentication code retrieved from database 112. In some such embodiments, activation engine 124 may generate the activation code to encode the payment card information within the activation code without encoding the authentication code within the activation code.

Card service provider server 102 may provide the generated authentication code to the cardholder, for example by including the generated authentication code in a message transmitted from card service provider server 102 to the cardholder. Such message may be transmitted to the cardholder via email, a short message service (SMS), a social media message, or any other suitable electronic communication method. Also, the payment card and the activation code generated for the payment card may be provided to the cardholder. For example, the activation code may be printed on the physical payment card provided to the cardholder, may be printed on a sticker attached to the physical payment card provided to the cardholder, may be provided to the cardholder separately (e.g., in a separate mailer) from the physical payment card, etc. In an embodiment, the card service provider may generate/manufacture the payment card and may provide the payment card to the cardholder. In this embodiment, card service provider server 102 may cause the activation code to be provided to the cardholder, for example by causing the activation code to be printed on the payment card to be provided to the cardholder, to be printed on a sticker to be attached to the payment card provided to the cardholder, or to be provided to the cardholder separately (e.g., in a separate mailer) from the payment card, etc. In another embodiment, generation/manufacturing of the payment card and provision of the payment card to the cardholder may be performed by the card issuer. In this embodiment, card service provider server 102 may provide the activation code, generated by card service provider server 102, to card issuer server 104. For example, activation engine 124 of card service provider server 102 may generate an activation code message that includes the generated activation code, and may transmit the activation code message via network 106 to card issuer server 104. Card issuer server 104 may then cause the activation code to be provided to the cardholder, for example by causing the activation code to be printed on the payment card to be provided to the cardholder, to be printed on a sticker to be attached to the payment card provided to the cardholder, or to be provided to the cardholder separately (e.g., in a separate mailer) from the payment card, etc.

Upon receiving the payment card, the cardholder may activate the payment card using a user device 138. User device 138 may be, for example, a mobile device such as a cellular phone, a tablet, a laptop, a wearable device, etc., or a stationary computing device such as a personal computer, which enable the user to communicate with card service provider server 102 via network 106. User device 138 is illustrated in FIG. 1 as including a processor 140 and a computer readable memory 142 that stores computer readable instructions executable by processor 140. Computer readable memory 142 may store an activation application 144. Computer readable memory 142 may include volatile memory to store computer instructions, such as Random Access Memory (RAM), and may also include persistent memory such as a hard disk, for example. In some embodiments, user device 138 includes multiple processors 140. Further, in some embodiments, activation application 144 may be implemented using hardware components, firmware components, software components, or any combination thereof.

Activation application 144 may allow the user of user device 138 to quickly and securely activate a payment card. Activation application 144 may be provided by a card service provider or a card issuer, for example. Activation application 144 may be a standalone application or may be incorporated into another application, such as a banking application or a card issuer's application that may be used to interface with card issuer after activation of the payment card. The user may download activation application 144 via network 106 and may install activation application 144 on user device 138.

Activation application 144 may prompt the user to enter the activation code that was provided for the payment card. For example, activation application 144 may prompt the user to electronically scan the activation code using a built-in camera of user device 138. Activation application 144 may the case the scanned activation code to be transmitted via network 106 to card service provider server 102. Scanning the payment code via card activation application 144 allows the cardholder to provide the activation code very quickly and conveniently to card service provider server 102, in an embodiment. However, other methods of providing the activation code to card service provider server 102 may be utilized in other embodiments. For example, the cardholder may manually enter the activation code into user device 138 (e.g., via card activation application 144), and user device 138 (e.g., via card activation application 144) may transmit the manually entered activation code to card service provider server 102, in an embodiment. As another example, in another embodiment, cardholder may take a picture of the activation code (e.g., using a built-in camera of user device 138), and user device 138 (e.g., via card activation application 144) may transmit the picture of the activation code to card service provider server 102.

Activation application 144 may also prompt that the user to enter the authentication code (e.g., the OTP) that was previously provided to the cardholder, such as in a message previously transmitted to the cardholder via email, a short message service (SMS), a social media message, or any other suitable electronic communication method. Activation application 144 may authenticate the user based on the authentication code entered by the user, for example by extracting the authentication code that was previously provided to the cardholder from the activation code and comparing the authentication code extracted from the activation code to the authentication code entered by the user. Activation application 144 may then transmit the activation code to card service provider server 102 only if the user is authenticated as the cardholder. Additionally or alternatively, authentication may be performed by card service provider server 102 (e.g., by activation engine 124). In this embodiment, card activation application 144 may transmit the authentication code entered by the user to card service provider server 102. In some embodiments, activation application 144 may prompt the user to enter a new code, such as a new password or personal identification number (“pin”), that the user wishes to set for the payment card, and may transmit the entered password or pin to card service provider server 102 along with the activation code for the payment card.

Upon receiving the activation code from user device 138 and, in some embodiments, authenticating the user as the cardholder, card activation engine 124 may extract payment card information from the activation code. Card activation engine 124 may then perform payment card activation using the payment card information extracted from the activation code, and without the need to obtain such information from another source such as a database. For example, card activation engine 124 may generate a card activation message that includes at least some of the payment card information extracted to the activation code, and may transmit the card activation message to card issuer server 104. The card activation message may also include the new password or pin provided by the user for the payment card. Card issuer server 104 may activate the payment card, and may transmit a confirmation message to card service provider sever 102. The confirmation message may confirm that the payment card has been activated and may also confirm setting of the new password or pin requested by the cardholder or the issuer, in various embodiments. Card service provider server 102 may then generate a final confirmation and may transmit the final confirmation message to the cardholder. The final confirmation message may inform the cardholder that payment card activation is completed. Additionally, the final confirmation message may confirm that the requested new password or pin for the payment card has been set.

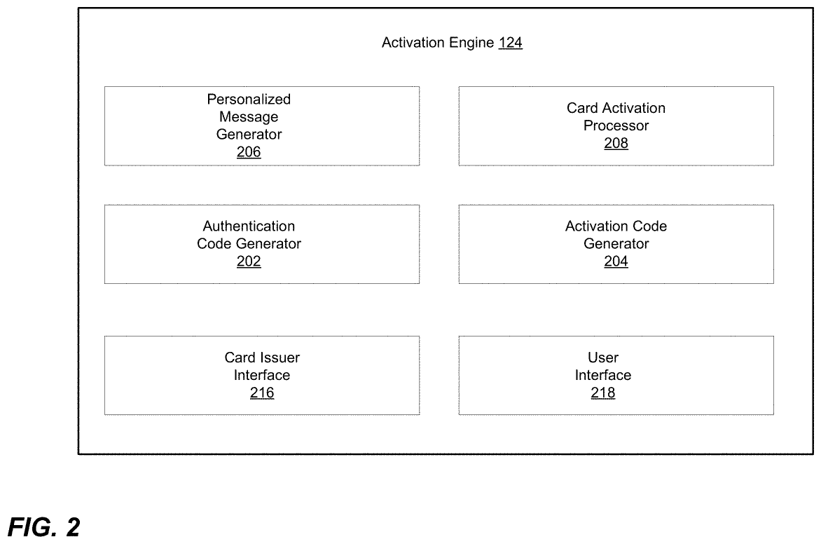

FIG. 2 is a block diagram of activation engine 124 of FIG. 1, according to an embodiment. In the illustrated embodiment of FIG. 2, activation engine 124 includes an authentication code generator 202, an activation code generator 204, a personalized message generator 206, a card activation processor 208, and several interfaces including a card issuer interface 216 and a user application interface 218. Card issuer interface 216 may be an application program interface (API) or another suitable type of interface configured to interact with an issuer application, such as issuer application that runs on card issuer server 104. User interface 218 may be an API or another suitable type of interface configured to interact with a card activation application, such as activation application 144 of user device 138.

In operation, activation engine 124 may receive payment card information that may be obtained from a payment card request received by card service provider server 102 from card issuer server 104 via card issuer interface 216. Payment card request may be in the form of a card order file provided by card issuer server 104, for example. Payment card information may include, for example, payment card number (e.g., credit card number, banking card number, gift card number, etc.), partial payment card number (e.g., last four digits of the credit card number, last four digits of the banking last four digits of the card number, gift card number, etc.), payment card verification code (e.g., credit verification value (CVV)), expiration date, cardholder name and the like.

Authentication code generator 202 may generate an authentication code for the payment card. The authentication code may include a random or pseudorandom generated number, a randomly or pseudo-randomly generated sequence of one or more alpha-numeric characters, or may include any other computer-generated code that may subsequently be used to authenticate and verify identity of the cardholder. The authentication code generated for the payment card by the authentication code generator 202 may be provided to the cardholder in any suitable manner. For example, the authentication code generated for the payment card by the authentication code generator 202 may be included in an electronic message, such as an e-mail, an SMS, a social media message and the like that may be transmitted to the cardholder. As another example, the authentication code generated for the payment card by the authentication code generator 202 may be mailed to the cardholder in physical form, such as via a mailer physically sent to the cardholder.

Activation code generator 204 may generate an activation code that encodes some or all of the payment card information obtained from the payment card request received by card service provider server 102. In some embodiments, activation code generator 204 may generate the activation code to further encode the authentication generated by the authentication code generated 202 for the payment card, in addition to encoding the payment card information received for the payment card. In some embodiments, prior to generating the activation code, activation engine 124 may encrypt the payment card information and/or the authentication code, and activation code generator 204 may generate an activation code that encodes the encrypted payment card information and/or the encrypted authentication code. The activation code may be an electronically scannable code, such as one-dimensional bar code or a multi-dimensional bar code, for example. In an embodiment, the activation code may be a quick response (QR) code, a universal product code (UPC), or any other suitable type of code that may encode payment card information in encrypted or unencrypted form.

Personalized message generator 206 may generate a personalized message to be sent to the cardholder. Personalized message generator 206 may generate the personalized message, for example, using a template retrieved from a memory, such as database 112 or another suitable memory. Personalized message generator 206 may select the template from among multiple templates stored in the memory. For example, respective ones of multiple templates stored in the memory may correspond to respective ones of multiple card issuers and/or respective ones of multiple types of cards, and personalized message generator 206 may select the template based on the card issuers and/or type of the payment card. The personalized message generated by the personalized message generator 206 may include a welcome note from the card issuer of the payment card, instructions on how to activate the payment card, a link (e.g., a web link) to access a digital welcome kit, issuer's specific marketing contents and the like. In an embodiment, the personalized message generated by the personalized message generator 206 may include the authentication code generated by the authentication code generator 202. The personalized message may be sent to the cardholder via any electronic or physical channel, including, but not limited to, an electronic message, such as an e-mail, an SMS, a social media message, etc.

The payment card may be generated/manufactured, and may be provided to the cardholder, for example via mail sent to the address that was provided for the cardholder in the payment card request received by card service provider server 102. Additionally, the activation code generated for the payment card by activation code generator 204 may be provided to the cardholder. For example, the activation code may be printed on the payment card provided to the user, may be printed on a sticker attached to the payment card provided to the user, or may be provided to the user separately (e.g., in a separate mailer) from the payment card, etc. In this embodiment, card service provider server 102 may cause the activation code to be provided to the cardholder, for example by causing the activation code to be printed on the payment card to be provided to the cardholder, to be printed on a sticker to be attached to the payment card provided to the cardholder, or to be provided to the cardholder separately (e.g., in a separate mailer) from the payment card, etc. In another embodiment, generation/manufacturing of the payment card and provision of the payment card to the cardholder may be performed by the card issuer. In this embodiment, card service provider server 102 may provide the activation code, generated by card service provider server 102, to card issuer server 104. For example, activation engine 124 of card service provider server 102 may generate an activation code message that includes the activation code generated by activation code generator 204, and may transmit the activation code message via card issuer interface 216 to card issuer server 104. Card issuer server 104 may then cause the activation code to be provided to the cardholder, for example by causing the activation code to be printed on the payment card to be provided to the cardholder, to be printed on a sticker to be attached to the payment card provided to the cardholder, or to be provided to the cardholder separately (e.g., in a separate mailer) from the payment card, etc.

Upon receiving the payment card and the activation code, the cardholder may activate the card using a user device, such as user device 138 (e.g., activation application 144 of user device 138. The cardholder may follow instructions for payment card activation previously provided to the cardholder, for example via the personalized message generated by personalized message generator 206. In an embodiment, activation application 144 may prompt the cardholder to scan the activation code that was provided to the cardholder with, or separately from, the payment card. In another embodiment, activation application 144 may prompt the cardholder to manually enter the activation code. In an embodiment, activation application 144 may additionally prompt the cardholder to enter the authentication code that was previously provided to the cardholder. Activation application 144 may authenticate the cardholder by extracting and, if necessary, decrypting an authentication code from the activation code scanned or otherwise entered by the cardholder and comparing the extracted authentication code to the authentication code entered by the cardholder. In another embodiment, cardholder authentication may be additionally or alternatively subsequently performed by activation engine 124. In some embodiments, activation application 144 may prompt the cardholder to enter a new password or pin that the cardholder wishes to be set for the payment card upon activation of the payment card.

Activation application may 144 may generate an activation request message, and may transmit the activation request message to card service provider server 102. The activation message may include the activation code that was, for example, electronically scanned by user device 138. The activation request message may additionally include the authentication code that was entered by the cardholder and/or the password or pin that was entered by the cardholder, in some embodiments. The activation request message may be received by activation engine 124 via user interface 218. Card activation processor 208 may extract the payment card information that is encoded in the activation code included in the received activation request. If necessary, card activation processor 208 may decrypt the payment card information extracted from the activation code. In some embodiments, card activation processor 208 may also implement an authentication process to authenticate the cardholder based on a comparison between an authentication code that is included in the activation request message and the previously generated authentication code for the payment card, such may be stored in database 112, for example.

Card activation processor 208 may then perform activation of the payment card using the payment card information extracted from the activation code, and without obtaining such information from database 112. For example, card activation processor 208 may generate an activation request that includes at least some of the payment card information extracted from the activation code, and may cause the activation request to be transmitted to card issuer server 104 via card issuer interface 216. The activation request may additionally include the new password or pin provided by the cardholder for the payment card, in an embodiment. Card activation processor 208 may subsequently receive a confirmation message received from card issuer server 104 via card issuer interface 216, the confirmation message confirming activation of the payment card at the card issuer server 104. In response, card activation processor 208 may generate a cardholder confirmation message indicating to the cardholder that the payment card activation process is completed, which may transmit the cardholder confirmation message to user device 138 via user interface 218, in an embodiment.

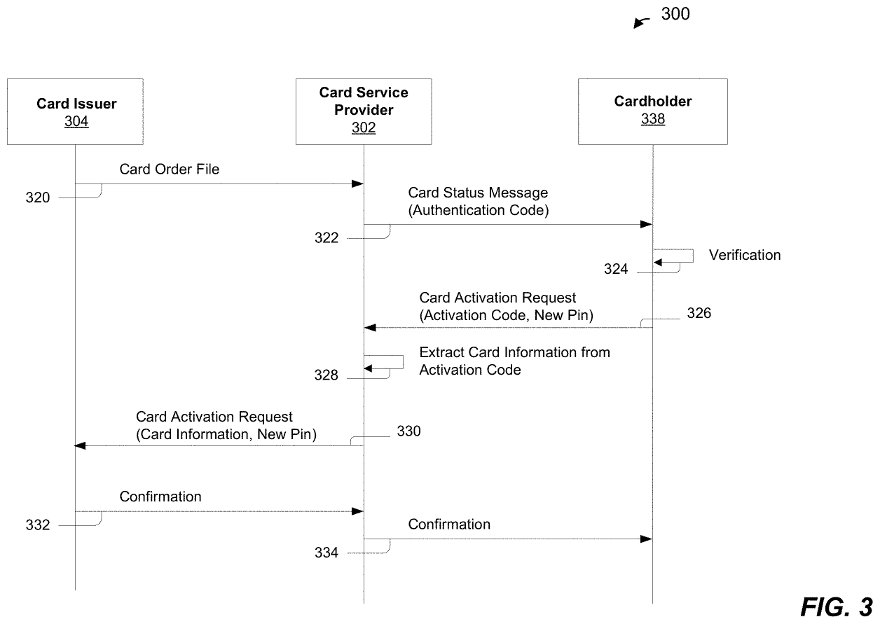

FIG. 3 is a diagram of an exemplary payment card activation process that may be implemented in the computing system of FIG. 1, according to an embodiment. A card issuer 304 may request a payment card to be provisioned by a card service provider 302 to a cardholder 338 and/or may request activation of a payment card to be provided by card service provider 302. For example, card issuer server 104 may transmit a request message 320 to card service provider server 102 to request the payment card to be generated/manufactured and provided to the cardholder and/or to request activation of a payment card to be provided by card service provider server 102. For example, card issuer server 104 may transmit request message 320 to request activation of a payment card to be provided by card service provider server 102 while the payment card itself may be provisioned to cardholder 338 by card issuer 304. Request message 320 may include payment card information, such as payment card number, partial payment card number, security code, expiration date, cardholder name, etc. Request message 320 may also include other cardholder information, such as cardholder email address, postal address, phone number, etc.

In response to receiving request message 320, card service provider 302 (e.g., card service provider server 102) may generate an authentication code to be provided to the cardholder to be subsequently used for authenticating the cardholder during activation of the payment card. The authentication code may be an OTP or may be any other suitable authentication code. Card service provider server 102 may provide the authentication code to cardholder 338, for example by including the authentication code in a card status message 322 that may be sent from the card service provider server 102 to cardholder 338. Card status message 322 may be sent to cardholder 338 for example by an e-mail sent to an e-mail address provided for cardholder 338 in request message 320, an SMS sent to a phone number provided for cardholder 338 in request message 320, or any other electronic or physical channel available for communication with cardholder 338.

Additionally, card service provider 302 may generate an activation code to be subsequently used for activation of the payment card. The activation code may encode at least some of the payment card information provided in the request message 320. In an embodiment, the activation code may additionally encode the authentication code generate for the payment card. The activation code may be an electronically scannable code, such as a one-dimensional or a multi-dimensional bar code (e.g., QR code), or may be another suitable type of code. Prior to generating the activation code, card service provider server 102 may encrypt the at least some of the payment card information, and may generate the activation code to encode the encrypted at least some of the payment card information.

The payment card may be manufactured/generated and provided to cardholder 338. Additionally, the activation code generated for the payment card may be provided by card service provider 302 to cardholder 338. For example, the activation code may be printed on a sticker that may be affixed to the payment card (e.g., affixed to a credit card, a banking card, a payment-enabled wearable device, etc.), or may be included in a mailer that is mailed to the cardholder together with, or separately from, the payment card. In an embodiment, card service provider 302 may generate/manufacture the payment card and may provide the payment card to the cardholder. In this embodiment, card service provider server 102 may cause the activation code to be provided to the cardholder, for example by causing the activation code to be printed on the payment card to be provided to the cardholder, to be printed on a sticker to be attached to the payment card provided to the cardholder, or to be provided to the cardholder separately (e.g., in a separate mailer) from the payment card, etc. In another embodiment, generation/manufacturing of the payment card and provision of the payment card to the cardholder may be performed by card issuer 304. In this embodiment, card service provider server 102 may provide the activation code, generated by card service provider server 102, to card issuer server 104. For example, card service provider server 102 may generate an activation code message (not shown) that includes the generated activation code, and may transmit the activation code message via network 106 to card issuer server 104. Card issuer server 104 may then cause the activation code to be provided to the cardholder, for example by causing the activation code to be printed on the payment card to be provided to the cardholder, to be printed on a sticker to be attached to the payment card provided to the cardholder, or to be provided to the cardholder separately (e.g., in a separate mailer) from the payment card, etc.

Subsequently, cardholder 338 may attempt to activate the payment card using the activation code provided for the payment card. Cardholder 338 may use a user device (e.g., user device 138) to electronically scan the activation code, for example. Additionally, user device 138 may prompt cardholder 338 to enter the authentication code that was provided to cardholder 338. User device 138 may implement a process 324 to verify or authenticate cardholder 338 based on a comparison between the authentication code entered by cardholder 338 and an authentication code obtained by user device 138 from the activation code. If the authentication code entered by cardholder 338 matches that authentication code obtained from the activation code, then user device 138 may transmit an activation request message 326 to card service provider server 102. Activation request message 326 may include the activation code provided by cardholder 338. In an embodiment, cardholder authentication may be additionally or alternatively performed by card service provider server 102. In this embodiment, activation request message 326 transmitted from user device 138 to card service provider server 102 may additionally include the authentication code entered by cardholder 338. In some embodiments, user device 138 may prompt the cardholder 338 to enter a new password or pin that the user wishes to be set for the payment card, and activation request message 326 may additionally include the new password or pin entered by cardholder 338.

Card service provider server 102 may receive activation request message 326 from user device 138, and may implement a process 328 to extract payment card information from the activation code. In an embodiment in which the payment card information was encoded in the activation code in encrypted form, process 328 may additionally decrypt the payment card information. Process 328 may additionally authenticate cardholder 338 based on authentication code that may be included in activation request message 326, in an embodiment.

Card service provider server 102 may then perform activation of the payment card using payment card information extracted from the activation code. For example, card service provider server 102 may generate card activation request message 330 to include payment card information needed by card issuer 304 to activate the payment card. Card activation request message may additionally include the new password or pin provided by cardholder 338. Card service provider server 102 may transmit card activation request message 330 to card issuer server 104. Subsequently, card service provider server 102 may receive a confirmation message 332 from card issuer server 104. Confirmation message 332 may indicate that the payment card has been activated by card issuer 304. Additionally, confirmation message 332 may indicate that the new password or pin has been set for the payment card by card issuer 304. In response to receiving confirmation message 332, card service provider server 102 may generate a confirmation message 334, and transmit confirmation message 334 to cardholder 338 (e.g., to user device 138) to inform cardholder 338 that activation of the payment card is completed.

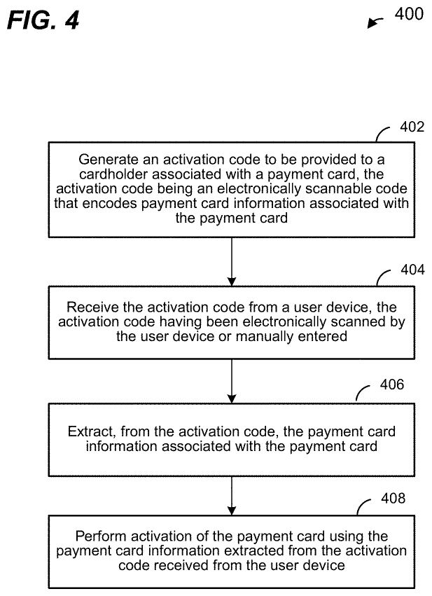

FIG. 4 is a flow diagram of a method 400 for payment card activation, according to an embodiment. In such an embodiment, method 400 is implemented by a card service provider server device such as card service provider server 102 of computing system 100 of FIG. 1. In an embodiment, method 400 is implemented at least partially by activation engine 124 of card service provider server 102 of computing system 100 of FIG. 1. In other embodiments, method 400 is implemented by suitable computing devices different from card service provider server 102 of FIG. 1 and/or in suitable computing systems different from computing system 100 of FIG. 1.

At block 402, an activation code to be provided to a cardholder associated with a payment card is generated. In an embodiment, card service provider server device 102 (e.g., activation engine 124 of card service provider server device 102) generates the activation code. In another embodiment, another suitable device generates the activation code. The activation code is an electronically scannable code that encodes payment card information associated with the payment card, in an embodiment. For example, the activation code is a one-dimensional bar code or a multi-dimensional bar code, such as a QR code, that encodes payment card information associated with the payment card, in an embodiment. The activation code is another suitable type of code that encodes payment card information associated with the payment card, in another embodiment. The payment card may be a credit card, a banking card, a gift card, virtual payment card, or any other suitable card or medium that may be used to make payments or obtain funds, for example. Payment card information encoded in the activation code may include one or more of i) a payment card number associated with the payment card, ii) a security code associated with the payment card, iii) an expiration date of the payment card and iv) a cardholder name associated with the payment card, etc., in various embodiments.

At block 404, the activation code is received from a user device. In an embodiment, card service provider server 102 (e.g., activation engine 124 of card service provider server 102) receives the activation code from a user device (e.g., user device 138). In an embodiment, the received activation code was electronically scanned by the user device. In another embodiment, the received activation code was manually entered by a user of the user device. At block 406, the payment card information associated with the payment card may be extracted from the activation code received at block 404. At block 408, activation of the payment card may be performed using the payment card information extracted from the activation code at block 404. In various embodiments, the method 400 provides a quick, convenient and secure payment card activation process for cardholders. For example, the method 400 allows the cardholder to compete the activation process by merely scanning the activation code using a mobile device, which may take only a few seconds of the cardholder's time, in at least some embodiments. Moreover, because the method 400 utilizes encoded payment card information to activate the payment card, the method 400 does not require transmission of sensitive payment card information, such as card number, security code, expiration date, etc. in a manner that may not be sufficiently secure for such transmission and may result in fraudulent use of the payment card, in at least some embodiments. Further, the method 400 eliminates the need for the card issuer to develop and maintain alternative, typically less secure and more expensive, payment card activation systems, such as on-line or over the phone payment card activation systems, in at least some embodiments.

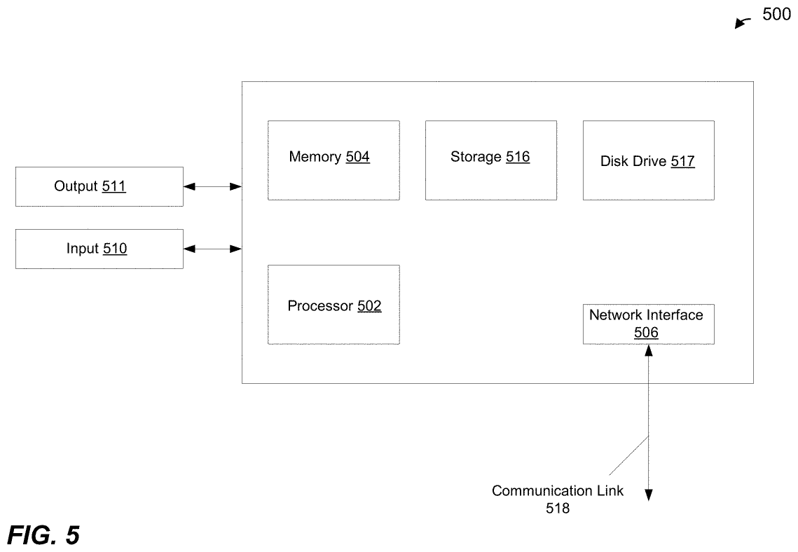

FIG. 5 is a block diagram of a computing system 500 suitable for implementing one or more embodiments of the present disclosure. In such an embodiment, each of one or more devices in the system 100 of FIG. 1 may be implemented as the computing system 500. In its most basic configuration, the computing system 500 may include at least one processor 502 and at least one memory 504. The computing device 500 may also include a bus (not shown) or other communication mechanism for communicating information data, signals, and information between various components of computer system 500. Components may include an input component 510 that processes a user action, such as selecting keys from a keypad/keyboard, selecting one or more buttons or links, etc., and sends a corresponding signal to the at least one processor 502. Components may also include an output component, such as a display, 511 that may display, for example, results of operations performed by the at least one processor 502. A transceiver or network interface 506 may transmit and receive signals between computer system 500 and other devices, such as user devices that may utilize results of processes implemented by the computer system 500. In one embodiment, the transmission is wireless, although other transmission mediums and methods may also be suitable.

The at least one processor 502, which can be a micro-controller, digital signal processor (DSP), or other processing component, processes these various signals, such as for display on computer system 500 or transmission to other devices via a communication link 518. The at least one processor 502 may also control transmission of information, such as cookies or IP addresses, to other devices. The at least one processor 502 may execute computer readable instructions stored in the memory 504. The computer readable instructions, when executed by the at least one processor 502, may cause the at least one processor 502 to implement processes associated with context data collection and user context generation for use in payment transaction authentication as described above, in some embodiments.

Components of computer system 500 may also include at least one static storage component 516 (e.g., ROM) and/or at least one disk drive 517. Computer system 500 may perform specific operations by processor 502 and other components by executing one or more sequences of instructions contained in system memory component 504. Logic may be encoded in a computer readable medium, which may refer to any medium that participates in providing instructions to the at least one processor 502 for execution. Such a medium may take many forms, including but not limited to, non-transitory media, non-volatile media, volatile media, and transmission media. In various implementations, non-volatile media includes optical or magnetic disks, volatile media includes dynamic memory, such as system memory component 516, and transmission media includes coaxial cables, copper wire, and fiber optics. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

While various operations of a credit card payment processing system have been described herein in terms of “modules” or “components,” it is noted that that terms are not limited to single units or functions. Moreover, functionality attributed to some of the modules or components described herein may be combined and attributed to fewer modules or components. Further still, while the present invention has been described with reference to specific examples, those examples are intended to be illustrative only, and are not intended to limit the invention. It will be apparent to those of ordinary skill in the art that changes, additions or deletions may be made to the disclosed embodiments without departing from the spirit and scope of the invention. For example, one or more portions of methods described above may be performed in a different order (or concurrently) and still achieve desirable results.

What is claimed is:

1. A method for payment card activation, the method comprising:
generating, at a processor of a payment card service provider server device, an activation code to be provided to a cardholder associated with a payment card, the activation code being an electronically scannable code that encodes payment card information associated with the payment card;
receiving, at the processor of the credit card service provider server device, the activation code from a user device, the activation code having been electronically scanned by the user device;
extracting, using the processor of the payment card service provider server device, the payment card information, associated with the payment card, from the activation code received from the user device; and
performing, using the processor of the payment card service provider server device, activation of the payment card using the payment card information extracted from the activation code received from the user device.

2. The method of claim 1, wherein the payment card information associated with the payment card comprises at least one of i) a payment card number associated with the payment card, ii) a security code associated with the payment card, iii) an expiration date of the payment card, and iv) a cardholder name associated with the payment card.

3. The method of claim 1, wherein the activation code is one of i) a one-dimensional bar code and ii) a multi-dimensional bar code.

4. The method of claim 1, wherein the activation code is a quick response (QR) code.

5. The method of claim 1, further comprising:
generating, at the processor of the credit card service provider server device, an authentication code for activation of the payment card; and
transmitting, with the processor of the credit card service provider server device, the authentication code to the cardholder associated with the payment card.

6. The method of claim 5, wherein:
generating the activation code comprises generating the activation code to further encode the authentication code for activation of the payment card, and
receiving the activation code for activating the payment card comprises receiving the activation code after the cardholder has been authenticated by a processor of the user device based on a comparison between the authentication code extracted from the activation code and an authentication entered by a user of the user device.

7. The method of claim 6, wherein generating the activation code includes:
encrypting i) the payment card information associated with the payment card and ii) the authentication code for activation of the payment card; and
generating the activation code to encode i) the encrypted payment card information associated with the payment card and ii) the encrypted authentication code for activation of the payment card.

8. The method of claim 1, further comprising:
receiving, at the processor of the payment card service provider server device from an issuer server device of an issuer of the payment card, the payment card information associated with the payment card; and
generating, at the processor of the payment card service provider server device, the activation code to encode the payment card information associated with the payment card.

9. The method of claim 8, wherein activating the payment card includes:
generating, with the processor of the credit card service provider server device, an activation request message that includes at least some of the information extracted from the activation code;
transmitting, with the processor of the credit card service provider server device, the activation message to the issuer server device of the issuer of the payment card;
receiving, at the processor of the credit card service provider server device from the issuer server device, a first confirmation message indicating that the payment card has been activated at the issuer;
in response to receiving the first confirmation message, generating a second confirmation message indicating that the payment card has been activated at the issuer; and
transmitting the second confirmation message to the user device.

10. The method of claim 1, wherein the payment card is one of i) a credit card, ii) a banking card, iii) a virtual payment card, iv) a payment-enabled wearable device and v) a gift card.

11. A tangible, non-transitory computer readable medium, or media, storing machine-readable instructions that, when executed by one or more processors, cause the one or more processors to:
generate an activation code to be provided to a cardholder associated with a payment card, the activation code being an electronically scannable code that encodes payment card information associated with the payment card;
receive the activation code from a user device, the activation code having been electronically scanned by the user device;
extract the payment card information, associated with the payment card, from the activation code received from the user device; and
perform activation of the payment card using the payment card information extracted from the activation code received from the user device.

12. The tangible, non-transitory computer readable medium, or media of claim 11, wherein the payment card information associated with the payment card comprises at least one of i) a payment card number associated with the payment card, ii) a security code associated with the payment card, iii) an expiration date of the payment card and iv) a cardholder name associated with the payment card.

13. The tangible, non-transitory computer readable medium, or media of claim 11, wherein the activation code is one of i) a one-dimensional bar code and ii) a multi-dimensional bar code.

14. The tangible, non-transitory computer readable medium, or media of claim 11, wherein the activation code is a quick response (QR) code.

15. The tangible, non-transitory computer readable medium, or media of claim 11, storing machine-readable instructions that, when executed by one or more processors, further cause the one or more processors to:
generate an authentication code for activation of the payment card;
cause the authentication code to be transmitted to the cardholder associated with the payment card; and
generate the activation code to further encode the authentication code for activation of the payment card, wherein receiving the activation code for activating the payment card comprises receiving the activation code after the cardholder has been authenticated by a processor of the user device based on a comparison between the authentication code extracted from the activation code and an authentication entered by a user of the user device.

16. The tangible, non-transitory computer readable medium, or media of claim 15, storing machine-readable instructions that, when executed by one or more processors, cause the one or more processors to:
encrypt i) the payment card information associated with the payment card and ii) the authentication code for activation of the payment card; and
generating the activation code to encode i) the encrypted payment card information associated with the payment card and ii) the encrypted authentication code for activation of the payment card.

17. The tangible, non-transitory computer readable medium, or media of claim 11, storing machine-readable instructions that, when executed by one or more processors, cause the one or more processors to:
receive, from an issuer server device of an issuer of the payment card, the payment card information associated with the payment card; and
generate the activation code to encode the payment card information associated with the payment card.

18. The tangible, non-transitory computer readable medium, or media of claim 17, storing machine-readable instructions that, when executed by one or more processors, cause the one or more processors to:
generate an activation request message that includes at least some of the information extracted from the activation code;
cause the activation message to be transmitted to the issuer server device of the issuer of the payment card;
receive, from the issuer server device, a first confirmation message indicating that the payment card has been activated at the issuer;
in response to receiving the first confirmation message, generate a second confirmation message indicating that the payment card has been activated at the issuer; and
cause the second confirmation message to be transmitted to the user device.

19. The tangible, non-transitory computer readable medium, or media of claim 11, wherein the payment card is one of i) a credit card, ii) a banking card, iii) a virtual payment card, iv) a payment-enabled wearable device and v) a gift card.

20. A payment card activation apparatus, the apparatus comprising:
an activation code generator implemented on one or more processor devices, the activation code generator configured to generate an activation code to be provided to a cardholder associated with a payment card, the activation code being an electronically scannable code that encodes payment card information associated with the payment card;
a user interface implemented on the one or more processor devices, the user interface configured to receive the activation code from a user device, the activation code having been electronically scanned by the user device; and
a card activation processor implemented on the one or more processor devices, the card activation processor configured to:
extract the payment card information, associated with the payment card, from the activation code received from the user device, and
perform activation of the payment card using the payment card information extracted from the activation code received from the user device.
